(19) United States
(12) Patent Application Publication
(10) Pub. No.: US 2010/0057580 A1
(43) Pub. Date: Mar. 4, 2010

(54) UNIFIED PAYMENT CARD

(76) Inventor: Radha Raghunathan, Shelton, CT (US)

Correspondence Address: WALTER J. TENCZA JR., 100 Menlo Park, Suite 210, Edison, NJ, 08837, US

(21) Appl. No.: 12/549,605

(22) Filed: Aug. 28, 2009

Related U.S. Application Data
(60) Provisional application No. 61/092,441, filed on Aug. 28, 2008.

(51) Int. Cl. G06Q 20/00; G07F 19/00; G06F 17/30; G06F 17/40; G06Q 40/00

(52) U.S. Cl. 705/17; 235/379; 707/10; 705/41; 235/380; 707/E17.044

(57) ABSTRACT

A consolidation system for consumer gift cards, prepaid purchase cards or loyalty accounts which allows the consumer the flexibility to maintain account with a variety of independent merchants, each account individually tabulated, and access to each account available from a single unitary universal membership card.

### CROSS REFERENCE TO RELATED APPLICATION(S)

The present application claims the priority of U.S. provisional patent application Ser. No. 61/092,441, titled “Unified Payment Card”, filed on Aug. 28, 2008.

### FIELD OF THE INVENTION

The present invention relates generally to pre-paid payment cards such as gift cards and prepaid credit cards. It also relates to customer loyalty programs or any membership program in which the member presents a card or paper certificate or copy of email or membership or presents the identification(ID) code/number to utilize its membership. It also relates to retailer/merchant or other coupons which are utilized through bar code or coupon code or paper certificates. It also relates to tickets/passes for travel, shows and other activities. Each of these gift cards, membership cards, loyalty program cards, coupons, tickets, passes are being carried as separate magnetic cards and/or paper certificates or electronic certificates.

### BACKGROUND OF THE INVENTION

Several retailers and merchants today offer gift cards of several different denominations. They also offer loyalty programs and other membership programs and coupons. Merchants related to travel and entertainment and sports and other activities offer tickets and passes. Most merchants also give gift cards instead of cash, for example in the case of return of merchandise. In addition, many credit card companies offer pre-paid gift cards. Each of these gift cards, membership cards, loyalty program cards, coupons, tickets, passes are being carried as separate magnetic cards/paper certificates/e-certificates(electronic certificates). There is no way to unify them in such a way that one entity keeps track of all the gift card balances and/or membership details and/or coupon information while preserving balances for each retailer/manufacturer/issuer.

Currently pre-paid purchase cards are issued by major credit companies and hundreds of thousands of individual retailers and service providers. A majority of current prepaid cards are purchased as a gift card. Sometimes rather than purchasing a gift for an anniversary, birthday, holiday or other occasion, a recipient receives a gift card with a prepaid spending amount. Thus the recipient can make the selection of item or items of their choosing.

The practice of giving gift cards is growing each year. Gift cards are considered by millions of consumers as a great alternative. Faced with innumerable choices, busy lifestyle, constant product exposure through various media, frenzied shoppers especially during the holiday season, seek the convenience of gift cards as a time-saving, fool proof alternative to an average gift.

However the majority of gift cards are merchant specific and not universal. That is a gift card purchased for a specific coffee house is valid for the prepaid amount only at that specific merchant, and not any retail merchant of the recipent's choosing. Similarly, a gift card purchased from a home improvement store would not be redeemable at a clothing retailer or vice versus.

A general purpose prepaid credit card has been offered by the major credit card companies. Like the prepaid gift card they are loaded with an initial spending amount but offer the convenience of being redeemable at any retail location which accepts that brand credit card. However these prepaid credit cards charge an initial convenience fee adding to the cost of the gift card making it an expensive alternative for the convenience.

Thus most consumers prefer to purchase specific individual gift cards redeemable at a particular merchant and obtain the full value of the prepaid amount on the card itself, free of any convenience fee.

In 2007, it is estimated that $35 billion worth of gift cards were bought in the United States during the holiday season alone, the total for the entire year topping a staggering $80 billion. The figure increases every year—2007 showed a steep 25% increase from the previous year. An average gift card buyer is estimated to spend over $200 on cards alone. Gift cards are also being embraced by consumers from all demographics—including teens.

However, while the gift card offers an improved value compared to prepaid credit cards there is another side to the picture that is often overlooked. Consumers lose nearly $8 billion annually—almost 10% of the gift card sales—due to unredeemed value, expiration or loss of cards. This is more than double the $3.5 billion estimated to be lost from debit and credit card fraud. Many gift cards also come with service fees that reduce the balance after a specific time lapse or a dormant period of use.

Gift cards make the consumers complacent—consumer does not feel a sense of urgency to redeem. Many mistakenly believe that the gift card is equivalent to currency. Retailers do not allow customers to exchange gift cards for money. Retailers also rely on gift cards to motivate customers to spend additional money on merchandise when they visit a location to redeem their cards, because many times the purchase amount will exceed the available balance.

Determining balances typically requires the card holder to visit the merchant, and in fact most balances are obtained as part of a purchase transaction. This furthers the notion that it is unavoidable to not exceed the remaining balance on the gift card, leaving the consumer then to pay the difference in cash or by other funds.

Currently the average consumer could have as many as a dozen gift cards. These cards are among several different retailers, and in most cases include multiple cards for the same retailers. This complicates the consumer optimizing their balances and redeeming the gift cards for purchases in an efficient manner.

Even if a consumer does not receive a prepaid card as gift, most hold gift cards as a result of a product return or purchase refund either without receipt or after the allowed time limit. Each time this occurs the consumer receives yet another gift card for the value of the return amount adding to their collection of prepaid cards.

As a result it is typical that prepaid card values are never fully realized by the consumer because they forgot to bring the card with them during their shopping trip, never redeem cards with only small balances, or loose the card itself.

Until now there has been no way for the consumer to consolidate and track their portfolio of gift or prepaid spending cards. To solve the aforementioned problems, the present invention has created a system of a Unified Gift Card that is a practical, manageable, and highly efficient solution to mitigate many of the problems currently associated with gift cards for both consumers and retailers.

There has also been no method by which the consumer could exchange or swap a gift card valid at one specific merchant for an equally valued gift card for a different merchant of their choosing.

Also, most individuals today carry a cell phone which has become indispensible in today's modern society. The present invention also involves associating and integrating UGC with customer's cell phone so that such a card can be presented/redeemed through the cell phone. This can be used in lieu of the plastic card with magnetic strip.

### SUMMARY OF THE INVENTION

One or more embodiments of the present invention relate to a universal pre-paid card system which allows owners to consolidate multiple gift card or prepaid credit card balances from a variety of retailers or vendors onto a single card account. One or more embodiments of the present invention may equally be used for consolidating customer loyalty membership cards, such as airline frequent flyer programs or restaurant rewards programs, retailer/merchant coupons which are utilized through bar code or coupon code, tickets/passes onto a single unified loyalty card or single unified gift card for eliminating the need for the member to retain individual membership cards for each provider.

A single unified gift card of one or more embodiments of the present invention may include but may not be limited to amounts from known gift cards, known customer loyalty membership cards, such as airline frequent flyer programs or restaurant rewards programs, and known retailer/merchant coupons which are utilized through bar code or coupon code, tickets/passes. The terms “unified gift card” (UGC) and “unified payment card” (UPC) are used interchangeably in the present application. In one or more embodiments of the present application, a unified gift card is not limited to amounts from existing “gift” cards, but rather as previously specified may include but may not be limited to amounts or data related to other types of cards, programs, coupons, rewards, tickets, passes.

One or more embodiments of the present invention may equally be used for integrating/associating the Unified Payment Card onto the customer's cell phone.

The following summary of the invention is provided to facilitate an understanding of some of the innovative features unique to the present invention. A full appreciation of the various aspects of the invention can only be gained by taking the entire specification, claims, drawings, and abstract as a whole.

In one or more embodiments of the present invention, a unified gift card is provided that is a practical, manageable, and highly efficient solution to mitigate many of the problems currently associated with gift cards for both consumers and retailers. The unified payment card consolidates information of multiple gift cards from a variety of retailers onto a single universal card.

According to a first aspect, the consumer no longer has to carry its complete portfolio of gift cards on a shopping trip, but instead has a single unified gift card onto which is registered each of the balances from the individual gift cards owned by the consumer.

In one or more embodiments of the present invention, computer software is provided that is capable of interfacing with several vendors' gift card data as well as capable of creating, maintaining and updating individual accounts for each unified gift card user. The computer software in one or more embodiments also allows the aggregation of different gift cards on one unified customer account that still allows the gift card amount to only be redeemed at the retailer for which that amount is associated. The computer software in one or more embodiments allows the current balance amount of the gift card to be displayed via a reader, such as a kiosk, located in all participating retailers. While the card balance is obtained at the time the consumer makes a purchase, the point of sale system can only verify the balance for registered cards valid at that specific merchant. But when the consumer reviews their card balance on the in-store reader (or alternatively using the website) balances for all registered cards are displayed for the consumer.

As a customer redeems his gift card, the system will account for this transaction and will update accordingly. However, unlike the prepaid credit card, one or more embodiments of the present invention will not allow a gift card amount from one store to be used for purchases at a different retailer. So while offering the convenience of carrying only a single card, it maintains the individual balances for each unique retailer.

Yet second aspect to the invention, the consumer can consolidate its balances from multiple gift cards with a given retailer into a single gift card amount thereby eliminating the possibility of lost cards or small balances which go un-used.

A third aspect to the invention, the consumer no longer has to visit the retail store or log onto multiple websites to determine the remaining gift card balance. Instead all of their gift cards are tabulated and the balances available for viewing upon the entry of single log-in to a single website.

A fourth aspect to the invention, records of spending and usage across all the registered gift cards are consolidated on a single tabulation. Reports are made available to the consumer on-line or mailed at predetermined intervals. Likewise this information can be viewed on kiosks located within merchant stores or in central places within a shopping mall. Historical records are available for viewing even many months after the card has been depleted or the usage occurred. The special software and its associated database maintains a historical accounting of all transactions for registered gift cards.

A fifth aspect to the invention, provides a network of members owning gift cards for a wide range of merchants. This facilitates the ability for card holders to swap, exchange, or purchase gift cards for other members, thereby putting small balances to use or exchanging the gift card value at an unwanted merchant for one at a merchant of choice.

A sixth aspect to the invention, provides a means to associate and integrate the Unified Payment Card with a customer's registered cell phone so that the Unified Payment Card identification number/code is displayed as a barcode on a customer's cell phone or integrated onto NFC (near-field communication) enabled cellphone. The card number/barcode in conjunction with the cell phone number which is the customer's registered cell phone number for the UGC (unified gift card) and a personal password to be supplied at the time of and/or any other biometric means of identification, and/or manual identification verification is used for verification of authenticity. More than one cell phone may be registered under one Unified Payment Card. One cell phone may be registered for more than one Unified Payment Card.

The present invention seeks to overcome or at least ameliorate one or more of several problems, including but not limited to: Lost cards, forgetting to bring the proper card on a shopping visit, un-used forfeited small remaining balances, unknown current balances, and in-ability for historical lookups.

### BRIEF DESCRIPTION OF THE DRAWINGS

FIG. 1 is a simplified block diagram of an apparatus for use in accordance with an embodiment of the present invention;

FIG. 2 is a simplified block diagram wherein multiple gift cards from different merchants are unified into a single unified gift card in accordance with an illustrative embodiment of the present invention;

FIGS. 3A and 3B together depict a flow chart for a process for registering a merchant gift card with a Unified Gift Card system in and adding the merchant gift card's balance onto an existing Unified Gift Card Balance in accordance with an embodiment of the present invention;

FIG. 4 shows a flow chart for a process for adding or updating gift cards, loyalty cards, or membership program information or coupons, tickets, passes to an existing customer Unified Gift Card account;

FIG. 5 shows a simplified block diagram of a payment process for an exemplary retailer or merchant in accordance with an embodiment of the present invention;

FIG. 6 depicts a simplified payment process for multiple retailers using multiple third party networks for payment processing in accordance with an embodiment of the present invention;

FIG. 7 is a flow chart for a Unified Gift Card transaction payment processing application in accordance with an embodiment of the present invention;

FIG. 8 is a simplified block diagram of a Unified Gift Card system infrastructure, database servers, software applications, and databases for administering a Unified Gift Card system in accordance with an embodiment of the present invention;

FIG. 9 is a simplified block diagram illustrating how a Unified Gift card validation process for multiple balances at multiple retailers would be used for payment, and illustrating how the updating of balances as the card is utilized in accordance with an embodiment of the present invention;

FIG. 10 shows a flow chart of another method in accordance with an embodiment of the present invention; and

FIG. 11 shows a flow chart of yet another method in accordance with an embodiment of the present invention.

### DETAILED DESCRIPTION OF THE DRAWINGS

One or more embodiments of the present invention provide a universal card system which consolidates account information from multiple merchants or retailers onto a single unified card which the customer carries eliminating the need for the customer to maintain an inventory of cards in their purse or wallet.

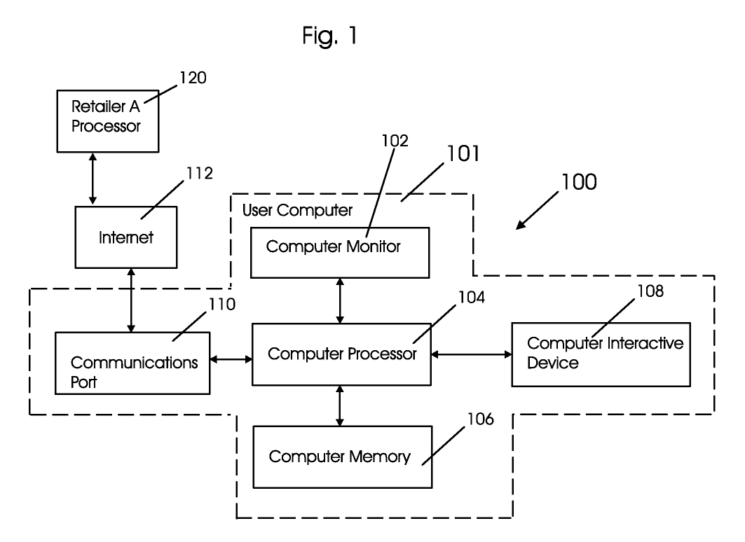

FIG. 1 is a simplified block diagram of an apparatus 100 for use in accordance with an embodiment of the present invention. The apparatus 100 includes computer monitor 102, computer processor 104, computer memory 106, computer interactive device 108, communications port 110, and internet 112. The computer monitor 102, computer processor 104, computer memory 106, the computer interactive device 108, and the communications port 110 may be part of a user computer 101. The computer memory 106 may have computer software located therein, which may be executed by the computer processor. The computer processor 104 may be connected by communications links to the computer monitor 102, the communications port 110, the computer memory 106, and the computer interactive device 108. The computer interactive device may include a computer keyboard, a touch screen computer display, a computer mouse, and/or any other computer interactive device.

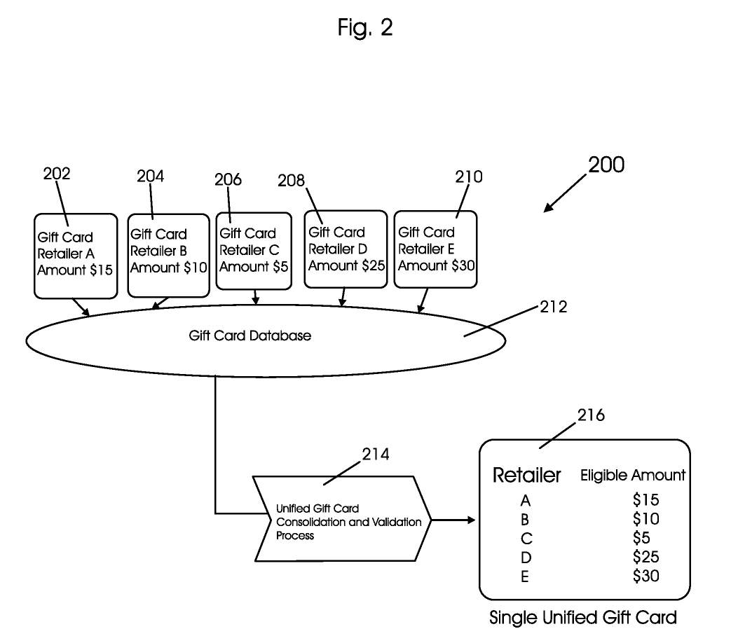

One or more embodiments of the present invention are applicable to and can consolidate a variety of account balances and/or account information for gift cards, pre-paid purchase cards, loyalty cards, frequent flyer or shopper programs (hereinafter generally referred to as the Unified Gift Card “UGC”) which is depicted in FIG. 2.

FIG. 2 is a simplified block diagram 200 showing how multiple gift cards from different merchants are unified into a single unified gift card in accordance with an illustrative embodiment of the present invention. The diagram 200 shows a simplified represenation of gift cards 202, 204, 206, 208, and 210. The gift cards 202, 204, 206, 208, and 210 refer to retailers A, B, C, D, E, respectively. Each of the gift cards 202, 204, 206, 208, and 210 may be a gift card known in the art to a specific retailer, such as a gift card to Barnes and Noble (trademarked), Sears (trademarked), or any other retailer. Each of the gift cards 202, 204, 206, 208, and 210 may have an amount of money on it. For example, gift cards 202, 204, 206, 208, and 210, may have $15, $10, $5, $25, and $30. As known in the art, an individual can use one of the gift cards at the appropriate retailer to purchase an item or to aid in purchasing in item. For example, an individual may use gift card 202 at retailer A to purchase an item for $15.00, or to pay $15.00 of a $25.00 item and provide the other $10.00 by some other means such as case.

In accordance with an embodiment of the present invention, data from the gift cards 202, 204, 206, 208, and 210 is supplied to a gift card database 212 which may be located in the UGC System Processor/sewrver 510. Data from the gift cards 202 may be scanned into computer memory 106 using a scanner which may be part of the computer interactive device 108, or the data from the gift cards may be typed in using a keyboard, entered through a touch screen display, entered using a computer mouse, or entered into the computer memory 106 in any other manner.

In accordance with an embodiment of the present invention, the UGC System Processor 510 may implement computer software including a unified gift card consolidation and validation process 214 identified in a simplified block diagram form in FIG. 2. The process 214 may receive the data from the gift cards 202, 204, 206, 208, and 210 and/or from the gift card database 212 and may supply the data to a single unified gift card 216. The data for the single unified gift card 216 may initially be stored in the UGC System database. The data stored on card account 216 may include data from the gift cards 202, 204, 206, 208, and 210, the appropriate retailers and the amounts of money available for purchase at each of the appropriate retailers. For example, the data stored on card 216 may include a table as shown in FIG. 2, with a first column including retailers and a second column including amounts or eligible amounts of money for each retailer.

In at least one embodiment of the present invention it is necessary for a consumer to first register for an account with the unified gift card system before they can begin enjoying its benefits. Consumers can submit a paper application containing their personal information such as name, address and phone number. The application may also contain account numbers or card numbers for gift cards or pre-paid purchase cards which they have. Additionally they can enter account information on loyalty, frequent flyer or shopper programs which they belong to.

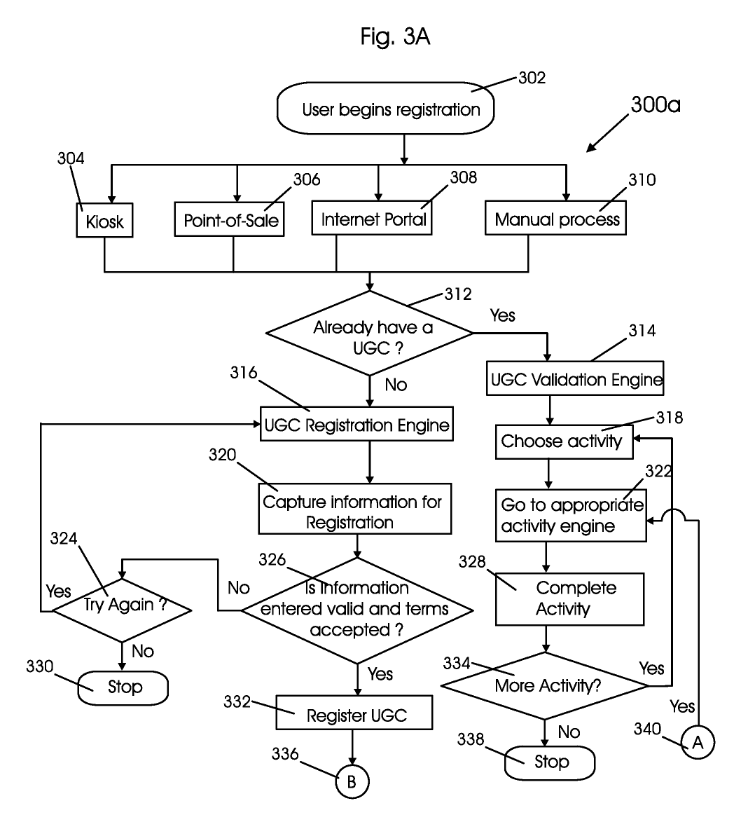

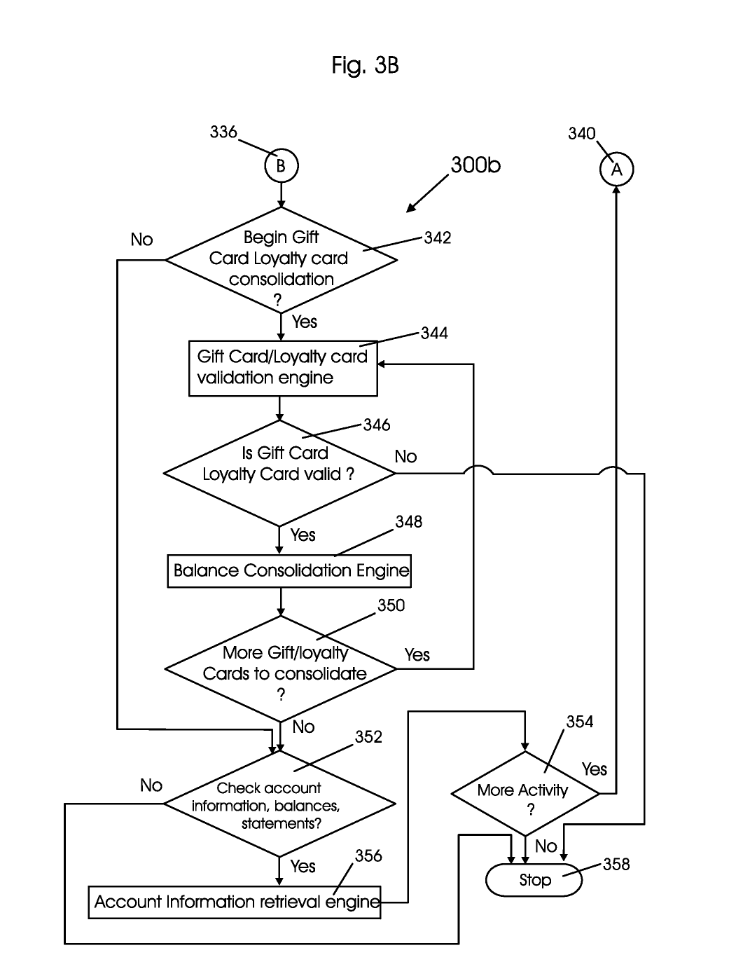

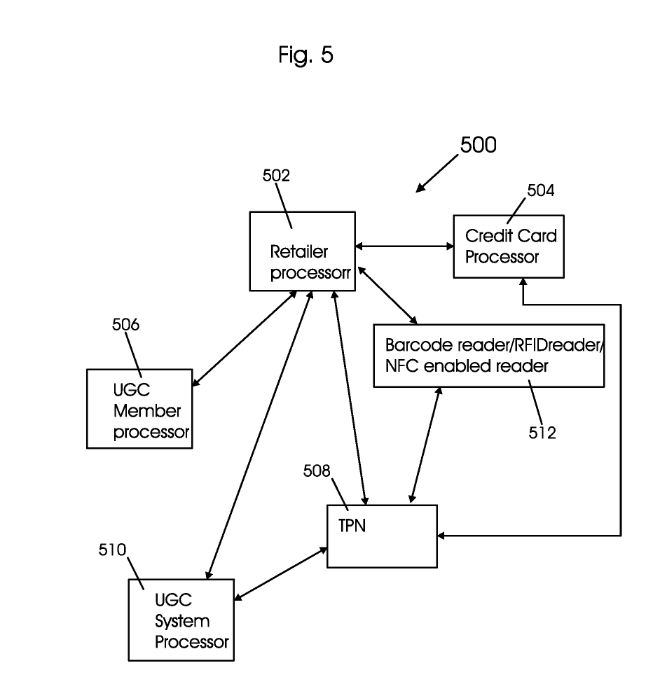

FIGS. 3A and 3B together show a flow chart of a registration process for a unified gift card in accordance with an embodiment of the present invention. The process starts at step 302 shown in FIG. 3A. The user may register using various devices, such as a kiosk at step 304, a point of sale device at step 306, an internet portal (such as by using computer processor 104 through communications port 110 and internet 112 in FIG. 1) at step 308, or a manual process (wherein the customer sends in the gift card or paper certificate to a UGC Collection/Processing center) at step 310. The registration process may be programmed on the UGC System Processor 510 shown in FIG. 5. During the registration process, the potential user will be asked whether he or she has a unified gift card (UGC) at step 312. This question may be presented as a computer prompt or field by the computer processor 104 on the computer monitor 102.

If the individual has a UGC already, the UGC system processor will next execute a UGC validation engine computer software program which will determine whether the UGC is valid. Identification data from the UGC may be scanned by a scanner and thereby supplied to the UGC System Processor/server 510. The UGC System Processor/server 510may examine the scanned in identification data from the UGC (unified gift card) at step 314 to determine if the UGC is valid. The UGC may be a several digit number and in case of portal access may not be entered right and be invalidated. This feature is also for fraud protection wherein a duplicate, erroneous or fraudulent card is invalidated.

The individual may choose an activity at step 318 using the computer interactive device 108. The activities can be: (a)reviewing summary of accounts; (b) checking balance retailer by retailer; (c) consolidating a new gift card onto UGC; (d) getting activity history by time period; (e) running reports such as getting list of retailer balance by expiry date; (f) buying a new gift card for self or someone else (g) sale/exchange of portion of balance for a retailer (h) logging to online community; and (i) changing account preference such as passwords, personal information, frequency of updates etc. The UGC System Processor/server 510may execute an appropriate activity engine or computer software program in response to the user's selection of activity at step 322. The UGC System Processor/server 510 may complete the activity at step 328 in response to a user's direction to complete the activity or for some other reason. The computer processor 104 may prompt the user whether more activities are desired at step 334, and if not the registration process ends at step 338. If a further activity is desired by the user, the process loops back to step 318.

If the individual does not have a Unified Gift card already at step 312, then the UGC system processor or server 510 executes the UGC registration engine computer software program at step 316. Information may be provided by a user into the computer interactive device 108 and may be captured at step 320 for registration. The UGC system processor or server 510 may store the registration information in UGC system database and memory and may compare the registration information with stored criteria in UGC system memory to determine if it is valid and if terms have been accepted by the user. If the registration information is valid and terms have been accepted, the UGC system processor 510 may register the Unified Gift card at step 332, such as by storing data, including identification data, concerning a new unified gift card in the UGC system database. The process would next continue with node B or step 336 which continues on FIG. 3B.

If the registration information is not valid and/or terms have not been accepted at step 326, then UGC system processor or server 510 at step 324 asks the user whether they want to try again. If the user provides an input through interactive device 108 that they do not want to try again, then the process stops at step 330. If the user wants to try again, the process loops back to step 316.

For the process continuing at step 336, node B in FIG. 3B, the UGC system processor or server 510 asks the user whether the user wants to begin a gift card and loyalty card consolidation process at step 342. If the answer is yes, the UGC system processor or server 510 executes a gift card/loyalty card validation engine or computer software program or process at step 344. Next the UGC system processor or server 510 determines whether the gift card and loyalty cards are valid at step 346. If the gift card and loyalty cards are valid, the UGC system processor or server 510 executes a balance consolidation engine or computer software process at step 348. The UGC system processor or server 510 then asks the user whether there are more gift cards and loyalty cards to consolidate at step 350. If the user answers yes, such as by input into computer interactive device 108, then the process loops back to step 344. If the user answers no, the UGC system processor or server 510 prompts the user to choose next activity such as for example checking account information or balancing statement at step 352 and if yes_ an account information retrieval engine or computer software process is executed at step 356. if no the process stops and allows the user to log out. The UGC system processor or server 510 determines if more activity is desired such as (a) reviewing summary of accounts; (b) checking balance retailer by retailer; (c) consolidating a new gift card onto UGC (unified gift card); (d) getting activity history by time period; (e) running reports such as getting list of retailer balance by expiry date; (f) buying a new gift card for self or someone else (g) sale/exchange of portion of balance for a retailer (h) logging on to online community; and (i) changing account preference such as passwords, personal information, frequency of updates etc. at step 354. If the answer is “no” then the process stops at step 358. If the answer is yes then the process loops back to step 340 or node A which continues in FIG. 3A.

If the user did not provide an input to begin gift card and loyalty card consolidation at step 342, then the process goes straight to step 352.

Referring to FIGS. 3A and 3B, the consumer registration process may, for example, be accomplished manually wherein the customer completes a registration form and mails it in to a UGC collection/processing center or calls a customer service representative over a telephone or computer or other means. Upon this, the registration, verification, update and consolidation are done by the customer service representative which may involve manually invoking various steps as explained in the various diagrams and text. In case of paper certificates especially those that cannot be stored on the merchant database and hence not available for verification electronically, the original paper certificate is collected, verified for authenticity, updated onto a UGC system database for the customer account and filed so that duplicate redemption is avoided. In case a tracking number is present on the paper certificate the participating retailer/merchant may choose to receive this information back and integrate onto their database or other tracking system for cross verification.

Referring to FIGS. 3A and 3B, the consumer registration process may, for example, be accomplished by the computer processor 104 accessing a unified gift card website portal on the internet 112 or through internet portal 308, which may be part of internet 112. This replaces the paper application and allows the consumer to register for an account with a unified gift card placing the same information into their unified gift card account as obtained from a paper application. The obvious advantage is that using the internet is more immediate and there are no delays as result of postal delivery.

Still yet referring to FIGS. 3A and 3B, another way for the consumer to register for their account with UGC (unified gift card), is by using kiosk 304 located at an individual retail location or in a shopping mall. The kiosk 304 combines the simplicity of the paper application with the more instantaneous result of using the internet method. A kiosk, such as kiosk 304, provides a computer interaction with the consumer as found if the consumer registered using a unified gift card (UGC) internet website through internet portal 308. The kiosk 304 may be operating a modified version of the UGC computer software web site interface which serves the dedicated purpose of registering UGC information.

Once again referring to FIGS. 3A and 3B, a further way for the consumer to register their information with a unified gift card is via a retailer at a point of purchase or point of sale 306 of a gift card. The merchant may enter the consumer information directly through their point of sale system 306, use a kiosk type device 304 or require the consumer to complete a paper application or use call center services through a manual process 310. Data from any of the systems or methods 304, 306, 308, and 310 would typically be provided to a computer processor, such as 104 in FIG. 1. The UGC System Processor 510 may execute most if not all of the steps in FIGS. 3A-3B.

In one embodiment of the present invention the consumer needs to register for a UGC account one time. Once registered, the consumer can update their account information using any of the aforementioned methods: paper or a manual process 310, internet portal 308, or kiosk 304, or point of sale device or system 306. Updates to a unified gift card account will register additional gift card or pre-paid card amounts, or add new loyalty, frequent flyer or shopper program information.

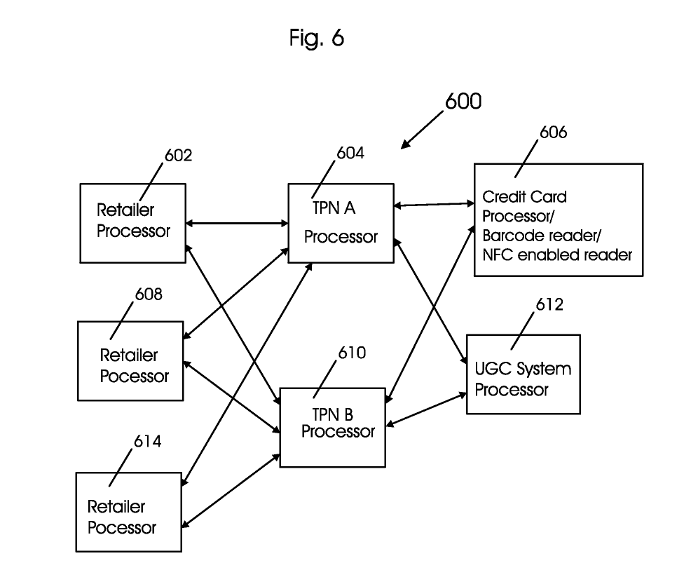

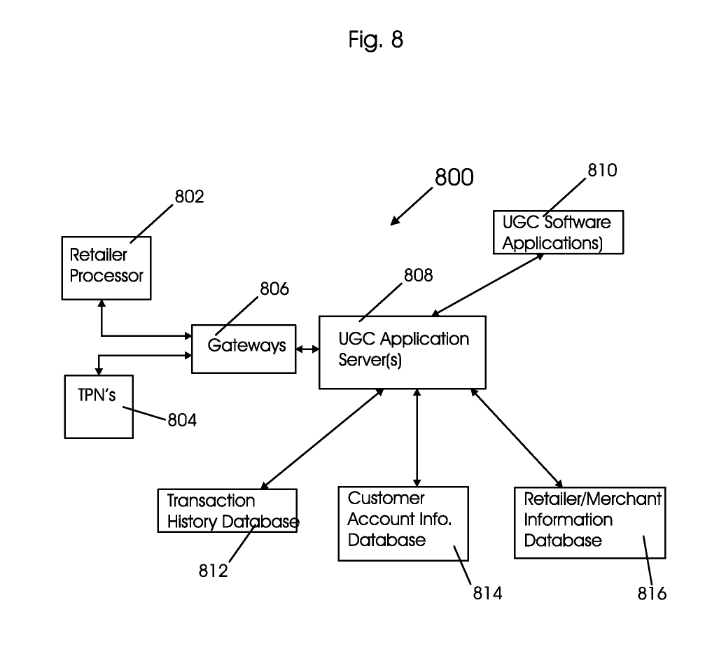

Retail merchants may utilize the unified gift card 216 shown in FIG. 2 and process transactions with the consumer who owns the unified gift card 216 through their in-store point of sale systems, such as 306, which contain credit card processing services. The processing of credit card transactions by a merchant may make use of various third party network systems (TPN) as shown in FIGS. 6 and 8.

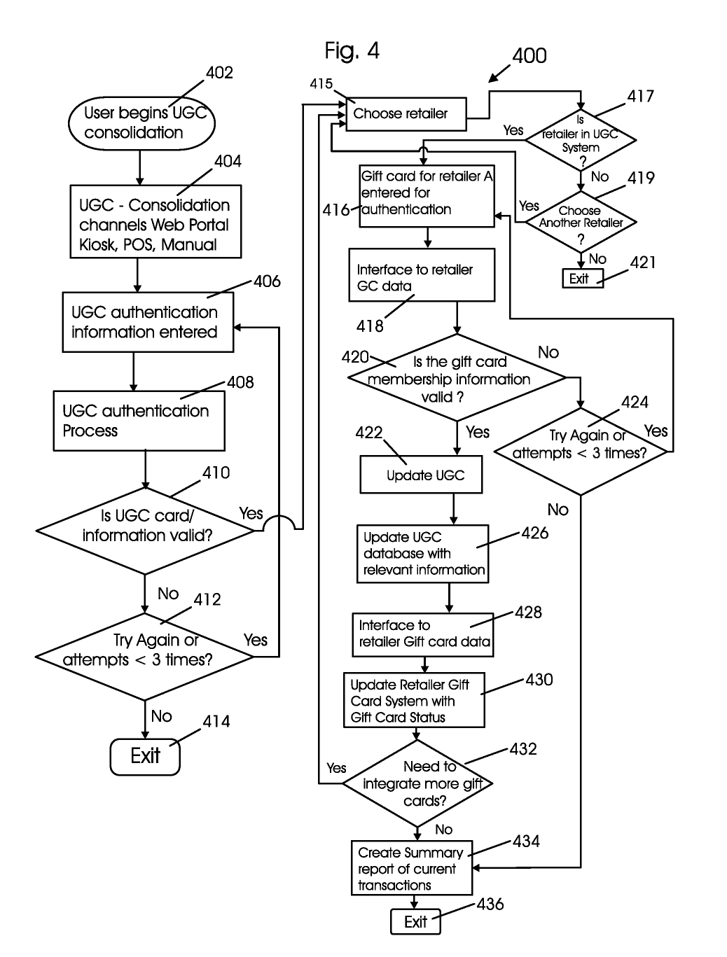

FIG. 4 shows a flow chart 400 for a process for adding or updating gift cards, loyalty cards, or membership program information,or coupons, tickets, passes to an existing customer Unified Gift Card account. The process shown by the flow chart 400 may be executed by computer software running on the UGC system processor or server 510. At step 402 a user may begin unified gift card consolidation. At step 404 data may be received by the computer processor 104 from the internet 112 (or internet portal 308), from kiosk 304 wherein the gift card to be consolidated can be swiped to be read electronically through any or combination of magnetic stripe reader, barcode reader, RFID(Radio Frequency Identification), NFC (Near Field Communication) enabled reader, from a point of sale system 306, or from input through computer interactive device 108 derived from a manual process 310. At step 406 unified gift card authentication information may be entered by a user (consumer) at a user computer not shown, which may be transmitted to the UGC system processor or server 510, whch may be a server computer. At step 408 a unified gift card authentication process computer program may be executed by the UGC system processor or server 510. The UGC system processor or server 510 may next determine if the UGC card and/or information relating thereto is valid at step 410. If the information is not valid at step 412, the process loops back to step 406, unless three or more attempts have been made in which case the process is exited at step 414.

If the information or UGC card is valid at step 410, the process continues at step 415. At step 415 a retailer is chosen by a user making a selection through computer interactive device 108 of the user computer 100. The selection may also be done through any of the consolidation channels such as web or internet portal device 308, POS (Point of sale) device 306 or Kiosk 304 or manually from a manual process 310. The portal device 308, point of sale device 306, or kiosk 304 may be connected to communications port 110 and thereby to user computer 100. In the case of web portal such as internet 112 of FIG. 1 or internet portal device 308 the computer processor 104 receives a signal regarding this selection, and sends a signal out on the internet 112 via communications port 110. The signal may go out to the UGC system processor 510 which may be connected to the internet 112. The UGC system processor 510, using computer software, may then determine if the retailer chosen by the user at step 415 is in the UGC system at step 417. If not, then the UGC system processor 510 may send a signal or message back to the user computer 100 via internet 112 that another retailer should be chosen as shown by step 419. If another retailer is not chosen, then the process is exited at step 421.

If a chosen retailer is in the UGC system, as determined by the UGC system processor 510, then at step 416, the user may enter through computer interactive device 108 or through a user computer connected via the internet 112, data for a gift card for retailer A (assuming retailer A was the chosen retailer), such as data for gift card 202 shown in FIG. 2. The data for the gift card for retailer A may be supplied at step 418 to an interface to retailer gift card data 418. At step 420, UGC system processor 510 may determine whether the gift card membership information for the gift card 202 is valid. If the gift card 202 membership information is not valid, the process loops back to step 416 to try to validate the gift card 202 information again, unless three tries or more have already been made as shown by step 424. If more than three tries at validation have been made, the process goes to step 434 where a summary report of current transactions is made UGC System Processor 510 and stored in the UGC System database. The process would then be exited at step 436.

If the gift card information is valid at step 420, as determined by the UGC system processor or server 510, then the uniform gift card data is updated at steps 422 and 426. The physical uniform gift card 216 may be updated at the same time by downloading data to computer chip located on a plastic gift card through a physical process known in the art. At step 428 UGC system processor or server 510 may interface to retailer A's gift card data to do validation. At step 430 the UGC System Processor 510 may update a retailer A gift card system with gift card status through the internet 112 by supplying data to a retailer A computer processor 120 shown in FIG. 1. At step 432 the UGC system processor or server 510 may ask a user if they want to integrate more gift cards. If not the UGC system processor or server 510 may create a summary report of current transactions at step 434 and exit the process at step 436. If yes then the computer software branch goes back to ‘choose retailer step’ at step number 415.

Referring to FIG. 4, it should be noted that it is not necessary for the UGC validation and transaction processing, such as shown by the process of FIG. 4, to utilize a TPN (third party network) comprised of a credit card clearing house. Instead the UGC system may interface to the merchant's systems with the UGC system's own gateway or a unique TPN (third party network) dedicated for UGC usage.

FIG. 5 shows a simplified block diagram 500 of a payment apparatus for an exemplary retailer or merchant in accordance with an embodiment of the present invention. The diagram 500 includes a retailer processor 502, a credit card processor 504, a UGC member processor 506, a Third party networks 508, a UGC system processor 510, and a barcode reader/RFID reader/NFC (Near-Field Communication) enabled reader 512. Each of the components 502, 504, 506, 508, 510, and 512 may include or may have dedicated thereto a computer processor, a computer monitor, a computer memory, a computer interactive device, and a communications port connected to the internet 112, similar to components 104, 106, 108, and 110 shown in FIG. 1.

The retailer processor 502 may be connected to the UGC member processor 506, the UGC system processor 510, the third party networks processor 508, and the credit card processor 504 by communications links. The UGC system processor 510 may be connected by a communications link to the TPN processor 508. The TPN processor 508 may also be connected by a communications link to the credit card processor 504. The Barcode reader/RFID reader/NFC enabled reader 512 may be connected by communications links to the retailer processor 502 and the TPN (Third Party Network) 508.

FIG. 6 depicts a simplified payment apparatus 600 for multiple retailers using multiple third party networks for payment processing in accordance with an embodiment of the present invention. The apparatus 600 includes retailer processors 602, 608, and 614, which may be for different retailers. The apparatus 600 further includes TPN A processor 604, TPN B processor 610, credit card processor 606, and UGC System processor 612. Each of the retailer processors 602, 608, and 614 is connected by communications links to TPN A processor 604 and TPN B processor 610. Each of the TPN A and B processors 604 and 610 are connected by communications links to credit card processor 606 and UGC system processor 612. Each of the processors 602, 604, 606, 608, 610, 612, and 614 may include or may have dedicated thereto a computer processor, a computer monitor, a computer memory, a computer interactive device, and a communications port connected to the internet 112, similar to components 104, 106, 108, and 110 shown in FIG. 1.

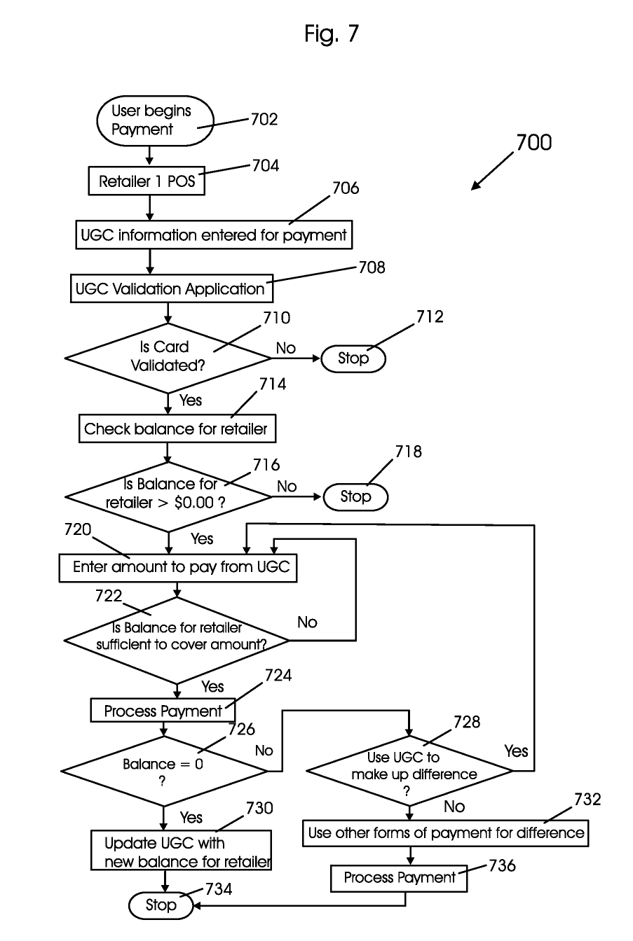

FIG. 7 is a flowchart 700 for a Unified Gift Card transaction payment processing and redemption application in accordance with an embodiment of the present invention. The process shown by the flow chart in FIG. 7 may be run on the UGC system processor or server 510 or may be run by TPN 604 or 610 shown in FIG. 6. At step 702, a user begins payment using a unified gift card, such as unified gift card 216 shown in FIG. 1. The unified gift card 216 may be scanned in at a retailer or data from the unified gift card 216 may be thereby supplied to a computer processor, like computer processor 104 at the retailer. The unified gift card data from card 216 may be entered through a point of sale such as terminal located at a retailer at step 704 or the payment gateway on internet portal accessed by the user through user computer. The UGC system processor or server 510 shown in FIG. 5, may use that information in executing a unified gift card validation application at step 708. UGC system processor or server 510 may determine if the unified gift card is valid at step 710. If not then the process stops at step 712. If the card is valid, then at steps 714 and 716, UGC system processor or server 510, if the balance for the particular retailer is greater than $0.00. If the answer is not, then the process stops at step 718.

If the answer if yes, then an amount to pay from the unified gift card is entered at step 720, such as by an employee of the retailer into the POS or by the user into a computer interactive device 108. UGC system processor or server 510 determines if the balance for the retailer on the unified gift card 216 is sufficient to cover the purchase price of the item or items at step 722. If the answer is no, the process loops back to step 720 so the user can choose to pay a different amount from the UGC which is within the balance or $0 if no balance exists. If the answer is yes the payment is processed by the retailer processor at step 724. At step 726, retailer processor determines if the balance is paid. If the answer is yes, then the unified gift card 216 is updated with a new balance for the particular retailer at step 730, and the process ends at step 734. If the answer is no, then the retailer processor uses the amount from the unified gift card 216 to make up the difference if so chosen by the user. The user may choose to use a different form of payment for the difference. For example, the balance for retailer A is $20 for user 1. User 1 needs to make a payment of $15. He could first choose to pay any amount<=payment balance which is less than or equal UGC balance for the retailer. For example, he may choose to pay $5 from UGC which is first processed. The system, implemented by computer software on a computer processor, allows to user to use the UGC again to cover full or part of balance until he chooses not to.

At step 728 the computer processor asks the user whether the UGC card 216 should be charged to make up the difference in price. If yes, then the process loops to step 720. If no, then the process continues at step 732 where the retailer processor receives other forms of payment to make up the difference in price. The retailer processor then processes payment at step 736 and the process ends at step 734.

FIG. 8 is a simplified block diagram 800 of a Unified Gift Card system infrastructure, database servers, software applications, and databases for administering a Unified Gift Card system in accordance with an embodiment of the present invention. The block diagram 800 a retailer processor 802, TPN (third party networks 804), gateways 806, unified gift card application server(s) 808, UGC software application(s) 810, transaction history database 812, customer account information database 814, and retailer/merchant information database 816. Each of the retailer processor 801, and the UGC application server(s) 808 may be a computer processor, and also may include or may have dedicated thereto a computer processor, a computer monitor, a computer memory, a computer interactive device, and a communications port connected to the internet 112. The databases 812, 814, and 816 may be located in a computer processor/memory. The UGC software application(s) 810 may be located in a computer processor/memory and may run on UGC application server(s) 808

The retailer processor 802 and the third party networks 804 may be connected by communications links to gateways 806 which are_interfaces to the processors and/or systems 802, 804, and 808). The gateways 806 may be connected to UGC application server(s) 808 through a communications link. Each of the databases 812, 814, and 816 may be connected to server(s) 808 through a communications link. The UGC software application(s) 810 may be connected to server(s) 808 through a communications link.

In order to utilize the third party network systems 804 shown in FIG. 8, various gateway interfaces 806 allow for the exchange of information and data between multiple TPNs 804 and also the merchant store level point of sale systems which may be included in the retailer processor 802 in FIG. 8. One or more embodiments of the present invention include gateway interfaces, such as 806, which may be comprised of computer processors and/orinterfacing computer software for sending and receiving transaction data from a merchant point of sale system, such as located in processor 802. One or more embodiments of the present invention also includes gateway interfaces, such as 806, for sending and receiving transaction data with any one of many different TPNs 804 who maintain customer account balance information for gift cards, pre-paid purchase cards, loyalty cards, frequent flyer or shopper programs or coupons, tickets, passes which are merchant or brand specific.

To facilitate functionality of a UGC system, as illustrated in FIG. 8, the block diagram 800 shows one or more central servers 808 which are located remotely from the retail establishments or locations where the UGC card is being presented by the consumer, for example at location of retailer processor 802. The central server(s) 808 typically contain the necessary database or databases containing UGC account identification, merchant identification, account balances by registered gift card. I.e. the databases 812, 814, and 816 may be part of the server(s) 808. Within the same or supplemental databases the specific detailed transaction history for each consumer may be maintained, such as in database 812. The server(s) 808 also contain the software applications, such as validation application, redemption application, registration application and others necessary to perform the functionality described herein, such as including application(s) 810 shown by FIG. 8.

One or more of the databases, such as 812, 814, and 816, as shown in FIG. 8, contain detailed information for each registered gift card. The detailed information in databases 812, 814, and 816 may include some or all of the following: the gift card identification number, barcode number, merchant identification or any other data or information which is available for the security of the gift card. While this information may be meaningless to the consumer, it can help the issuing merchant identify, track and verify the gift card.

The transaction history record, which may be contained in database 812, will contain information for each transaction by the member which is attributable to a specific gift card. The records in database 812 may contain date of the transaction, place of transaction, merchant identifier, amount of the transaction, and type of transaction. The transaction type may be a debit to the account, stored in database 812, indicating that value for the specific gift card is being reduced by the transaction amount. Likewise, the transaction time may be a credit, stored in database 812, in which the consumer account value is increased by some amount because additional value has been purchased, points have credited or a refund credit has been received.

Further in one or more of the databases 812, 814, and 816, of FIG. 8, detailed account information on the consumer member may be maintained. This information may include the consumer name, address, phone number, email address, date of creation for their account, date of last activity. The account information may also include identification information such as a social security number, account id, password, and challenge questions with answers. The secret questions and answers are used in the event the consumer forgets their password.

In the event the consumer forgets their password they may be able to reset their password or update it with a new password, provided they can answer one or more challenge questions. The challenge questions are chosen by the consumer and answers recorded when the account is established. The challenge questions can also be updated periodically by the member through administration functions accessible using the UGC website.

To access administrative functions, the member may log into a UGC system running on server 808, using the user computer 101 through the internet or an internet portal 112 utilizing a identification and a password. Once the identification and password are validated by the server 808, the member has access to their account information, current registered gift cards, balances, historical transaction history, and personal information created when they created their UGC account (or as maintained in the prior edits). The consumer can edit, change, delete or update personal information, and add/delete/change gift cards registered within the UGC system using a user computer.

It is understood that the aforementioned information will be retained in one or more of the UGC databases 812, 814, and 816 in FIG. 8, or further databases, for the purposes of the member utilizing the benefits of the UGC system as outlined above.

Similarly, as shown in FIG. 8, the UGC system executed by server(s) 808 maintains information on merchants that would participate in the system. If a merchant participates in the UGC system then gift cards, prepaid purchase cards, loyalty cards or other membership programs the merchant offers are available for inclusion in the UGC system. If the merchant information is not maintained in the UGC system, then consumers are not be able to register their gift cards for that specific merchant in their UGC account.

The merchant information maintained in one or more of the UGC databases 812, 814, and 816 may contain merchant identification, merchant name, and optionally merchant address information. The necessary information to facilitate data exchange between merchant information systems such as for example between retailer processor 802 and the UGC system running on server(s) 808 are also contained within the aforementioned merchant account information with the UGC database(s) 812, 814, and 816.

While the merchant account information is maintained in one or more of the UGC databases 812, 814, and 816, specific software applications in the form of gateways 806 may in some embodiments be required to facilitate the exchange of information between the UGC system running on server(s) 808 and the merchant's own information systems, such as running on processor 802, such as their point of sale systems. The gateways 806 allow for transaction information at the merchant location, such as at processor 802, to be updated in one or more of the UGC database(s) 812, 814, and 816.

When a consumer transaction occurs at the merchant location, such as at location of processor 802, the data on the consumer transaction is transmitted to the UGC system or to the server(s) 808. Likewise the merchant information systems, such as 802, can receive account validation information or account balance information from the UGC system running on server(s) 808, by utilizing one or more of the gateways 806. It should be understood that in one embodiment a specific merchant or retailer processor, such as 802, can only receive information from the UGC system server(s) 808 which relates to a gift card which have been registered and are applicable to their operations. Henceforth if a consumer has registered gift cards from multiple merchants, when the consumer utilizes their UGC card at a specific merchant, the merchant can only access information specifically associated with that merchant. This may be programmed into the computer software running on the server(s) 808.

For efficiency purposes multiple gateways for gateways 806 may be established for a single merchant or retailer processor, such as 802, if desired without impacting the overall functionality of the UGC system as described. One gateway for 806 may be used for validating consumer account information on the UGC system implemented by server(s) 808. Another gateway for gateways 806 may be used for processing debits and credits to consumer accounts within the UGC system. Whether individual gateways are used for these purposes, or a single gateway is used, the results obtained in conjunction with the UGC system is identical.

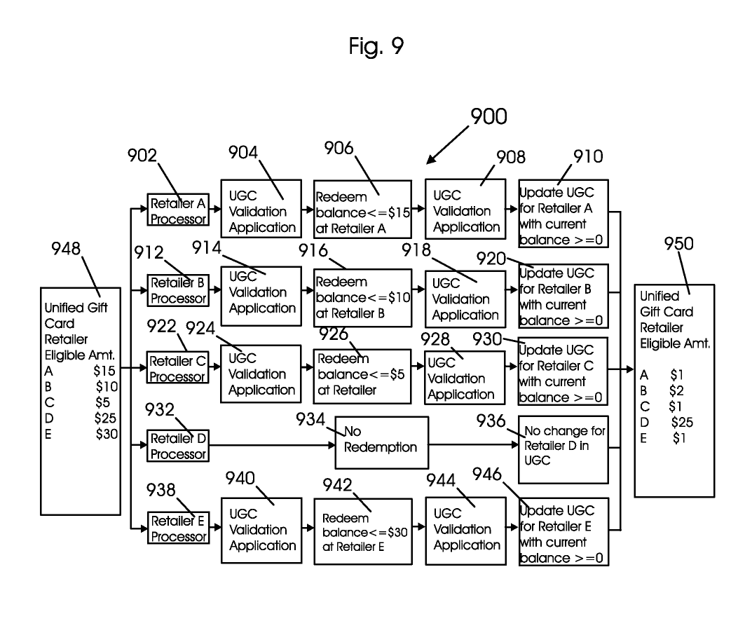

FIG. 9 is a simplified block diagram 900 illustrating how a Unified Gift card validation process for multiple balances at multiple retailers would be used for payment, and illustrating how the updating of balances as the card is utilized in accordance with an embodiment of the present invention. The block diagram 900 includes a representation of a unified gift card 948. The unified gift card 948 may have a table stored thereon or data concerning. The table or data may include a first column of retailers and a second column of amounts available for purchasing at those retailers. For example, the unified gift card 948 shown in FIG. 9 has data stored thereon to show a balance of $15.00 for retailer A, a balance of $10.00 for retailer B, a balance of $5.00 for retailer C, a balance of $25.00 for retailer D, and a balance of $30.00 for retailer E. Data from the unified gift card 948 may be provided to any one of retailer processor A 902, retailer processor B 912, retailer processor C 922, retailer processor D 932, and retailer processor E 938.

If the data is provided to retailer processor A 902, that processor 902 may execute a UGC validation application computer program on the processor 902 to determine if the card 948 is a valid card. In at least one embodiment of the present invention validation is always performed before usage of UGC to avoid fraudulent activities. The processor could be a card reader which will use an interface into the UGC database. Retailer A processor 902 can be an interface to the retailer's payment or POS system. The processor 902 may execute a program which causes a certain amount of money of the start balance of $15.00 on card 948 for retailer A, to be redeemed at retailer A in step 906. A UGC validation application computer software program 908 running on the processor 902 may do another validation before updating the UGC. The balance for the unified gift card 948 for retailer A may be updated by a computer software program running on processor 902 at step 910. An output device which is part of processor 902 may cause the card 948 to change its state to the card 950, with a different amount available for retailer A. I.e. the amount has been changed from $15.00 to $1.00 for retailer A. The unified gift card 950, although numbered differently from the card 948 in FIG. 9, may be the same card with the exception of data changed in memory for the amounts available at each retailer.

Similarly, if the data is provided to retailer processors B-C or E, 912, 922, and 938, those processors may execute a UGC validation application computer program 914, 924, and 940, respectively, on the processors 912, 922, and 938, respectively, to determine if the card 948 is a valid card. The processors 912, 922, and 938 may execute a program which causes a certain amount of money of the start balances of $10.00, $5.00, and $30.00 on card 948 for retailers B, C, and E to be redeemed at retailers B,C, and E in steps 916, 926, and 942, respectively. UGC validation application computer software programs 918, 928, and 944 running on the processors 912, 922, and 938, respectively, may do what. The balance for the unified gift card 948 for retailers B, C, and E may be updated by a computer software program running on the processors 912, 922, and 938 at steps 920, 930, and 946, respectively. An output device which is part of processors 912, 922, and 938 may cause the card 948 to change its state to the card 950, with a different amount available for retailers B, C, and E. I.e. the amount has been changed from $10.00 to $2.00 for retailer B; from $5.00 to $1.00 for retailer C; and from $30.00 to $1.00 for retailer E.

FIG. 9 also shows a situation where there has been no redemption from retailer D. Therefore a retailer D processor 932 does not execute a redemption at step 934 and no change is executed at step 936. The amount for retailer D remains at $25.00 in both card 948 and card 950. Referring to FIG. 5, when the consumer registers their individual gift card or pre-paid card(s), or loyalty, frequent flyer or shopper program(s) information, it should be understood that each of these may be for different merchants, retailers or brands as shown in FIG. 1. Therefore while the UGC consolidates these various cards and programs for the convenience of the consumer, the respective balances in one embodiment typically need to be maintained on an individual basis.

There is an exception which allows for consolidation of amounts. This means that—while consolidation of amounts for different merchants is prohibited unless authorized by said merchants, if several gift cards exist for same merchant they can be consolidated—for example two gift cards for Walmart (trademarked) are consolidated under ‘Walmart’ (trademarked) for multiple gift cards or pre-paid purchase cards. If there are gift cards or pre-paid purchase cards valid for use at the same merchant, then each individual balance may be consolidated using the UGC into a single amount. This is an extremely useful benefit of the UGC, since quite routinely, as described earlier in this application, small balances remaining on gift or pre-paid purchase cards are forfeited because they go un-used.

The UGC may also be used to retain information on store refunds, which are similar to pre-paid purchase cards. These refunds are issued by many merchants in the form of shopping cards which are essentially gift cards with a specific balance. Likewise the UGC treats the refund cards as just another form of a gift card. Consolidating the balance on a refund card with other balances for gift cards or pre-paid shopping cards which are valid at a common merchant is additional benefit to the UGC.

Once registered for the first time, the consumer receives a personal UGC card. This card may be magnetic stripe, barcode type or electronic media (such as radio frequency identication or smart cards which only need be placed in the vicinity of the reader for recognition). It is understood that the UGC card, such as card 216 in FIG. 2, may in fact have one or more of the aforementioned attributes.

Once registered in the UGC, the consumer receives a unique UGC ID which identifies their account. For each gift card, pre-paid shopping card, loyalty program, or frequent shopper program account registered, the sponsor merchant or organization identification and current balance is maintained in the UGC database.

Through gateway interfaces, such as 806 in FIG. 8, the UGC 216 connects to individual TPN systems, such as 804 associated with the merchant identification to validate the consumer account information and current balance with that specific merchant program (gift card, pre-paid shopping card, loyalty program, or frequent shopper program, etc.,). This is done initially when the consumer creates their UGC account, or whenever consumer updates their UGC account with additional gift cards, pre-paid shopping cards, loyalty program, or frequent shopper program or coupon, ticket/pass information. Similarly, the UGC system, such as running on server(s) 808, can query through the appropriate gateway of the gateways 806, to the TPN 804 for the specific merchant whenever the consumer utilizes their UGC card for a transaction or at periodic intervals even without a specific activity event initiated by the consumer as maybe randomly established. The systems accomplishing the above functions are illustrated in at least FIGS. 5 through 8.

The individual TPN systems, such as TPN systems 804, which hold gift card, pre-paid shopping card, loyalty program, or frequent shopper program coupon information etc., are typically merchant or brand specific. While it is possible that multiple merchants or loyalty type program sponsors may utilize a common TPN, the member balances for each sponsor are maintained separately and individually. Therefore the UGC gateway of gateways 806, which connects to a TPN of TPN's 804, and exchanges data may be unique not only on a TPN by TPN basis but also on a sponsor by sponsor basis within a given TPN.

Common to all UGC gateways, such as gateways 806, is the necessity to maintain a sponsor identification, designation data identifying its TPN, and the consumer account identification for that program. Gateways, such as gateways 806 may vary in the data format and communications interface required to access the specific TPN and for proper send/receive of data exchange between the TPN and the UGC system.

Referring to FIG. 7, when a consumer attempts a transaction at the merchant location at steps 702 and 704 the consumer will typically swipe the magnetic stripe of their UGC card in a card reader, which may be part of a computer interactive deivce 108, or alternatively scan the barcode or place the UGC card in the vicinity of a RFID (radio frequency identification) reader or NFC reader usually located at a merchant's point of sale equipment, such as at retailer processor 802. The card reader is interfaced to the merchant's point of sale system or part of processor 802 and the UGC card is identified as a UGC card (just as a credit card is identified as Visa, Mastercard, Discover, etc.).

At the time of the transaction, the consumer can specify whether to charge all or just a portion of the transaction amount against their gift card balance or balances at that specific merchant. If less than the full transaction amount is selected for redemption using the available gift card balance, then an additional payment method such as cash, credit card or check will be necessary.

The UGC card information may, in one embodiment, be sent from the merchant point of sale system, such as from retailer processor 602 of FIG. 6, through their internal systems and processed by a TPN, such as TPN A processor 604, such as those comprising a credit card clearing house as illustrated by FIG. 6. Now referring to FIG. 6, the credit card clearing house credit card processor 606 (to allow the processing of UGC as another payment option) or TPN A processor 604, interfaces with the UGC system 612 through a gateway, not shown in FIG. 6, and validates UGC account information. If the UGC account information is valid the transaction will proceed to the next step. However if the UGC account is invalid or for some other reason suspended, the credit card clearing house, such credit card processor 606 in FIG. 6 (see above—UGC is another payment option) will deny the transaction and transmit such information back to the merchant location, such as at retailer processor 602. Once received at the merchant location the transaction with the consumer will be denied.

However it is expected in most cases that the UGC card information will be validated and the transaction will proceed to the next step. If this transaction is simply to record purchase activity or accrue loyalty points, the UGC account associated with the consumer and the appropriate program associated with the merchant location will be updated, that is the balance for that specific UGC account and sub-account will be updated, as shown in FIG. 8. At the appropriate time, the UGC system will transmit the consumer activity including the transaction amount being applied against the gift card balance through the appropriate TPN to the merchant system for updating the account records, and the UGC balance for the specific merchant account and the merchant's internal systems (which may be available on a TPN) will be reconciled.

The term “gift card” in the present application includes a gift card, prepaid purchase, loyalty program account or other type of consumer account which has been registered within a UGC (unified gift card) system in accordance with an embodiment of the present invention for a specific consumer member.

Referring to FIG. 8, the aforementioned gateways 806 may connect directly to the information systems maintained and operated by the merchants or retailer processor 802. Alternatively, the connection between the merchant information systems, such as 602 and the UGC system or server(s) 612 may use TPN network interfaces, such as in FIG. 6. These TPNs are systems such as credit card clearing houses which consolidate and process the merchant transactional activity for the purposes of approving purchases when consumer account balances are positive, and declining the purchase activity when the consumer balances are negative or zero.

Regardless of whether the information exchange between the UGC system, such as in FIG. 8 where the server(s) 808 is connected directly to the merchant information systems, such as retailer processor 802 through gateways 806, or such as in FIG. 6 wherein the retailer processor 602 is connected to the UGC system processor 612 through a TPN A processor 604, the merchant systems, such as processor 802 and the third party networks 804 are processed through servers and databases which are distinct and separate entities. from the UGC system, its server(s) 808 and its database(s) 812, 814, and 816.

Alternate embodiments may be devised without departing from the spirit or the scope of the invention. For example, the multiple databases 812, 814, and 816 shown in FIG. 8 may be accomplished by the use of a single database. The multiple server(s) 808 referred to may be replaced by a single more powerful computer.

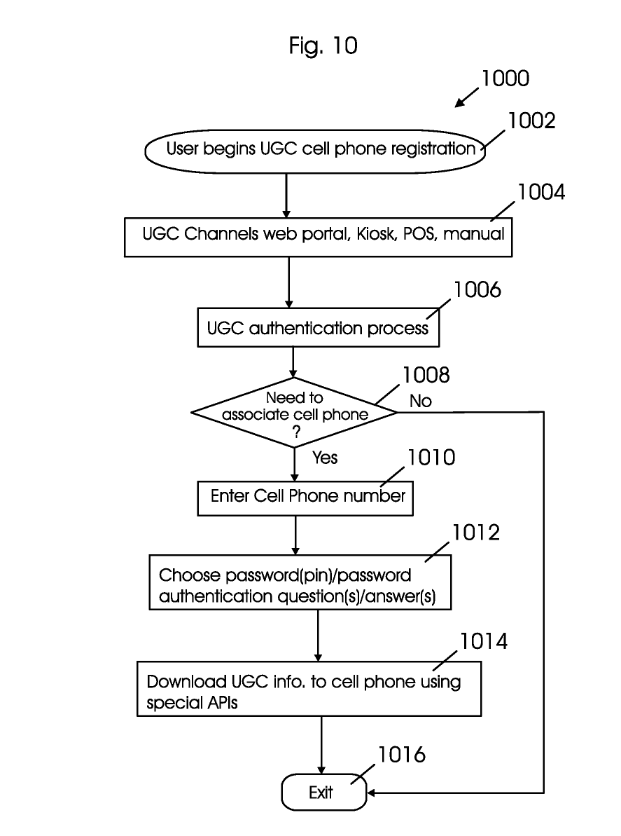

FIG. 10 shows a flow chart 1000 of yet another method in accordance with an embodiment of the present invention. The method of flow chart 1000 may be executed in whole or in part by use of a computer software program running on the computer processor 104 of the user computer 100 in case of use through the internet portal 308 shown by FIG. 3A or internet or internet portal 112 shown by FIG. 1 or, the kiosk 304 shown by FIG. 3A (which may be connected to communications port 110), the POS (point of sale) device 306 (which may be connected to communications port 110) or manually. At step 1002, a user may begin unified gift card (UGC) cell phone registration, such as by entering login or identification information into the computer processor 104, via computer interactive device 108 which is then supplied via computer processor 104, communications port 110, and internet 112 to the retailer A processor 120 shown in FIG. 1. At step 1004, the user begins access of the UGC system. To do so the user may enter user identifiation/login information into the computer interactive device 108 of the user computer 100, which is sent to the UGC system processor or server 510 shown in FIG. 5, via the processor 104, communications port 110, and the internet 112. The UGC system processor or server 510 authenticates the user identification/login information at step 1006 and provides authentication information to the user computer 100 via the internet 112 and communications port 110.

At step 1006, the UGC system processor or server 510, executes, using computer software, a unified gift card authentication process to authenticate the unified gift card registration entered by a user at step 1004. At step 1008, a user chooses the option to associate the UGC with a cell phone number by entering information into the computer interactive device 108 of the user computer 100. If not, then the procedure is exited at step 1016. If yes, then a cell phone number is entered by a user into for example the computer interactive device 108 at step 1010, and the cell phone number is supplied to UGC System Processor 510 via the computer processor 104, communications port 110, and internet 112. At step 1012, the user also chooses a password(pin) and/or password, and authentication questions(s)/answer(s) via the computer interactive device 108 in response to questions provided via the UGC System Processor 510. At step 1014, the user downloads unified gift card information such as the UGC number, barcode and other information, RFID or NFC enabled card identification information etc from UGC system procession 510 using special APIs (Application Program Interfaces), so that the cell phone is now ready to be used in lieu of the plastic card for UGC. Then the procedure is exited at step 1016.

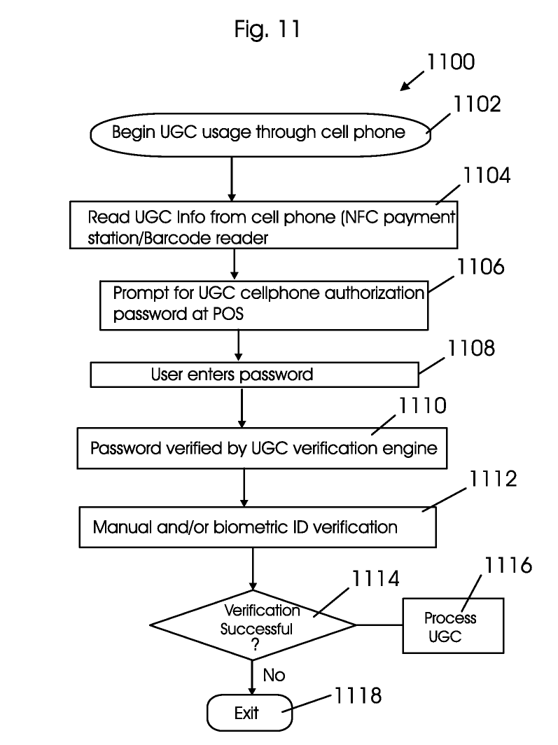

FIG. 11 shows a flow chart 1100 of another method in accordance with an embodiment of the present invention. At step 1102 of the flow chart 1100, the customer during payment presents the unified gift card (UGC) by use of a cell phone. The UGC may be read from the corresponding UGC barcode from the cellphone. Or if the cell phone is NFC (Near Field Communication) enabled then the UGC can be read automatically by the NFC enabled reader (512) when the cellphone is within range. Similarly the UGC information can also be read using RFID reader.

Once the UGC number is read, at step 1106, a prompt may be provided to enter password for the registered cellphone for UGC from the POS to authenticate the UGC and corresponding owner of the phone. At step 1108 the user may enter a password at the POS through TPN 508 At step 1110, the UGC system processor 510 may then verify the user's password using a UGC verification engine or computer program located on the UGC system Processor 510. At step 1112, further ID verification may be done manually by a sales associate based on name displayed on the NFC reader or RFID reader, using accepted form of verification such as Driver's License, passport etc. A further biometric ID verification may also be done. At step 1114, the computer processor 104 determines if the manual and/or biometric identification of the user is successful. If not then the process is exited at step 1118. If yes, then the unified gift card number provided by the user is processed at step 1116 using UGC system processor 510.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a gift card having a memory on which is stored a first amount of money, a second amount of money, a first retailer identification of a first retailer, and a second retailer identification of a second retailer;
wherein the first retailer identification associates the first amount of money with the first retailer, so that the first amount of money can be used to buy an item from the first retailer but not from any other retailer;
wherein the second retailer identification associates the second amount of money with the second retailer so that the second amount of money can be used to buy an item from the second retailer but not from any other retailer; and
wherein the first retailer and the second retailer are different.

2. The apparatus of claim 1 further comprising
a unified payment card reader;
a computer processor; and
a computer monitor;
wherein the unified payment card reader and the computer monitor are connected by communications links to the computer processor;
wherein the computer processor is programmed by computer software to cause the unified payment card reader to read the memory of the gift card and to supply information regarding the first amount of money, the second amount money, the first retailer identification, and the second retailer identification to the computer processor; and
wherein the computer processor is programmed by computer software to cause the information regarding the the first amount of money, the second amount money, the first retailer identification, and the second retailer identification to be displayed on the computer monitor.

3. The apparatus of claim 2 further comprising
a communications port connected to the computer processor by a communications link;
wherein the computer processor is programmed by computer software to cause the downloading of the first amount of money, and the first retailer identification from a first retailer processor through the internet through the communications port; and
wherein the computer processor is programmed by computer software to cause the downloading of the second amount of money, and the second retailer identification from a second retailer processor through the internet through the communications port.

4. The apparatus of claim 3
wherein the computer processor is programmed by computer software to update the first amount of money when a user uses the gift card to purchase an item.

5. The apparatus of claim 3
Wherein the computer processor is programmed by computer software to update the first amount of money when a user combines money from another retailer for the gift card.

6. An apparatus for consolidating consumer accounts comprising:
a first database;
a first computing device containing said database;
wherein the first database contains information records of at least a first customer identification and a first gift card balance of a first gift card;
a first gateway for exchanging information between the first database and one or more independent merchant information systems;
wherein the first gateway is configured to receive a first set of customer transaction data from the one or more independent merchant information systems;
wherein the first gateway is programmed to transmit the first set of customer transaction data to the first database;
wherein the first database is programmed to update the first gift card balance in response to the first set of customer transaction data.

7. The apparatus of claim 6 wherein
the first computing device is programmed with one or more computer software applications that allow registration of one or more gift cards, consolidation of customer accounts regarding the one or more gift cards, redemption of customer accounts regarding the one or more gift cards, tabulation of account usage by user for all retailers over periods of time for one or more gift cards, exchange/sale of account balances with other users regarding the one or more gift cards, providing redemption of one or more gift cards through a barcode reader, a radio frequency identification reader, near field communication reader, and a credit card processor.

8. The apparatus of claim 6 further comprising
at least one processing/handling center for paper certificates and manual processing of unified gift card registration, and consolidation of amounts of money and update of account information.

9. The apparatus of claim 6 further comprising
at least one customer service call center for customer service and manual processing of unified gift card registration, and consolidation of amounts of money and update of account information.

10. The apparatus of claim 6 further comprising
at least one interface between a retailer processor and a unified gift card system processor containing retailer user account and identifying information which is used by a unified gift card system processor for registration, consolidation, and authentication of user accounts to a unified gift card account

11. A method comprising
storing a first amount of money, a second amount of money, a first retailer identification of a first retailer, and a second retailer identification of a second retailer on a memory of a gift card;
wherein the first retailer identification associates the first amount of money with the first retailer, so that the first amount of money can be used to buy an item from the first retailer but not from any other retailer;
wherein the second retailer identification associates the second amount of money with the second retailer so that the second amount of money can be used to buy an item from the second retailer but not from any other retailer; and
wherein the first retailer and the second retailer are different.
